(19) United States
(12) Patent Application Publication
(10) Pub. No.: US 2009/0314229 A1
(43) Pub. Date: Dec. 24, 2009

(54) VALVE DEVICE

(76) Inventors: Swen-Juri Bauer, Stuttgart (DE); Andreas Gruner, Hattenhofen (DE); Martin Janssen, Stuttgart (DE); Rudiger Knauss, Kernen i.R. (DE); Clemens Schupp, Stuttgart (DE)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 12/487,001

(22) Filed: Jun. 18, 2009

(30) Foreign Application Priority Data
Jun. 19, 2008 (DE) 102008029118.8
Oct. 21, 2008 (DE) 102008052455.7

(51) Int. Cl. F01P 7/14; F16K 31/02; G05D 23/12

(52) U.S. Cl. 123/41.08; 251/129.01; 236/92 R

(57) ABSTRACT

The invention relates to a valve device (2) in a flow line (1) of an internal combustion engine, in particular in a cooling or an oil circuit. Pertinent to the invention is that the valve device (2) is designed in such a manner that it exhibits, at least in an open state, no or only very minimal flow resistance.

The present invention relates to valve device within a flow line of an internal combustion engine according to the preamble of claim 1. The invention moreover relates to an internal combustion engine equipped with such a valve device as well as a motor vehicle having such an internal combustion engine.

A large portion of the energy from delivery pumps in circuits of internal combustion engines, for example in oil or coolant circuits, is conventionally spent by the delivery pump having to convey against flow resistance. Investigations have shown that only 10% of the delivery energy of a delivery pump is used for the actual delivery of the fluid, while 90% of the delivery energy is consumed for overcoming the flow resistance within the circuit.

The invention is therefore concerned with the object of providing for a valve device of the generic type an improved or at least a different embodiment that makes possible in particular the use of lesser-performing delivery pumps with the same delivery capacity.

This object is solved according to the invention through the subject matter of the independent claims. Advantageous embodiments are the subject matter of the dependent claims.

The invention is based on the general idea of designing a valve device of the type in question in such a manner that when it is at least in the completely open state, it offers no or absolutely minimal flow resistance. In so doing, the valve device can be arranged in the known manner within a flow line of an internal combustion engine, in particular within a cooling or an oil circuit. In contrast to conventional valve devices in which, even when in a completely open state, a valve body still protrudes into a flow cross section, thereby generating flow resistance that is not to be underestimated, the valve device according to the invention is designed in such a manner that such a valve body is positioned completely outside the flow cross section when the valve device is completely open, meaning that the valve device thereby preferably no longer offers any flow resistance. Owing to the high number of valve devices in circuits of internal combustion engines, only minimal amounts of current resistance can accumulate and thereby make pump capacity to convey a fluid flowing through the flow lines necessary, which pump capacity requires a majority of the pump's delivery capacity in order to overcome the flow resistance present in the flow line network. However, if, for example, the valve devices are designed in such a manner that in the open state they preferably no longer offer any flow resistance whatsoever, the delivery capacity that has to be raised by the delivery pump to overcome the flow resistance can be kept to a minimum, and thus the delivery pump can have a smaller dimension with the same delivery capacity, by means of which costs and installation space advantages, in particular, can be realized.

In an advantageous development of the solution according to the invention, the valve device has a rotatable perforated roll. The rotatable perforated roll is easily mounted so little energy must be spent on moving it. The perforated roll is moreover conceived in such a manner that it has at least one through-opening that communicates with the flow line when the valve device is open in such a manner that the valve device itself when in its open sate represents nearly no flow resistance for the flowing fluid. By rotating the roll, which is entirely simple and involves as little energy as possible as previously described, the through-hole that initially was arranged flush with the flow line is eventually closed in such a manner that a stream flowing through the valve device is interrupted. When the valve device according to the invention is in an open state, it is preferably possible therewith to maintain a pressure differential Δp of approximately zero, the pressure differential Δp representing a differential of a fluid pressure in front of and behind the valve device. The overall reduced flow resistance upon use of such valve devices makes it possible for the pumps responsible for conveying the fluid to have a smaller dimension, thereby enabling both energy and installation space to be saved. With the use of such a valve device, the carbon footprint of an internal combustion engine equipped therewith is improved in particular since the pumps must, in such an instance, raise their capacity primarily for conveying fluid and not, as had previously been the case, for overcoming the flow resistance existing inside of the line.

In an advantageous development of the solution according to the invention, the valve device has at least one valve piston that does not protrude into a cross-section when the valve device is completely open. The at least one valve piston is preferably adjustable transversely to the direction of flow and is positioned outside the cross-section of the flow when the valve device is fully open. In this manner, the valve piston also generates no flow resistance, thereby reducing the pressure differential Δp conventionally present in such valve devices. It goes without saying that perforated rollers and valve pistons are only two embodiments of the valve device and are to be regarded purely as examples, such that other rotatable, swivelable, or translationally adjustable valve bodies are also conceivable, which nevertheless all have in common that when the valve device is completely open, they do not influence the cross-section of flow and particularly do not protrude thereinto.

Additional important features and advantages of the invention can be found in the dependent claims, in the drawings, and in the pertinent description of the figures with reference to the drawings.

It is understood that the features described above and those to be described in what follows can be used not only in the particular cited combination; but also in other combinations or independently without departing from the scope of the present invention.

Preferred embodiments of the invention are shown in the drawings and are described in more detail in the following description, the same reference numerals referring to components which are the same or functionally the same or similar.

The figures show in schematic diagrams

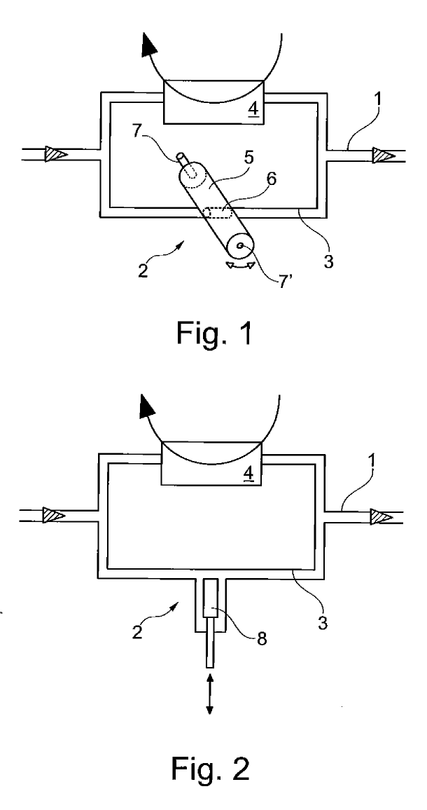

FIG. 1 a possible embodiment of a valve device according to the invention,

FIG. 2 a representation as in FIG. 1, however of a different embodiment,

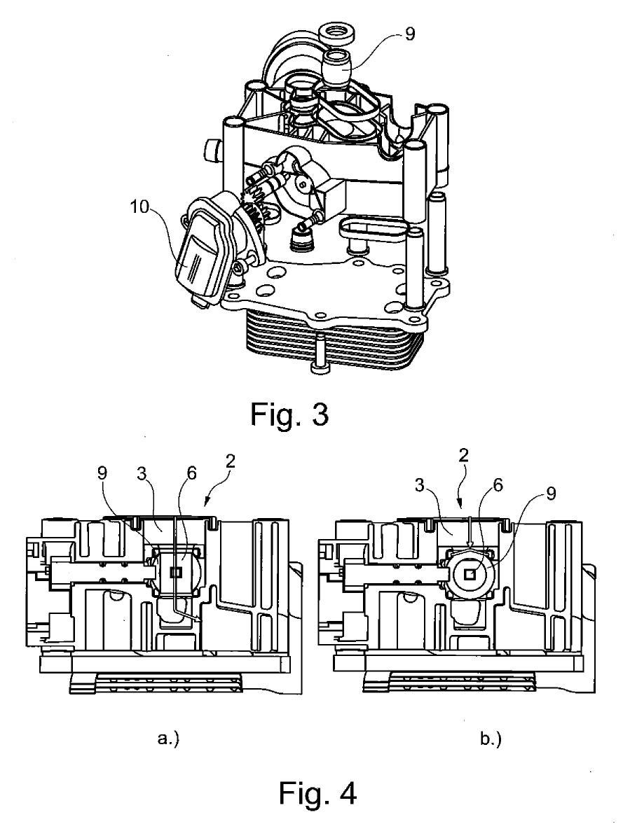

FIG. 3 an additional embodiment variant with a valve device designed as a ball valve,

FIG. 4a the valve device designed as a ball valve in the open state,

FIG. 4b the valve device designed as a ball valve in the closed state.

Corresponding to FIGS. 1 and 2, a valve device 2 according to the invention is arranged in a flow line 1 of a circuit, for example of a cooling or an oil circuit, of an internal combustion engine of a motor vehicle. In the representations according to FIGS. 1 and 2, the valve device 2 according to the invention is positioned in a bypass line 3 to a heat-exchanging device 4. According to the invention, the valve device 2 is now designed in such a manner that it exhibits or forms at least in its open state no or only very minimal flow resistance.

For this purpose, the valve device 2 according to the invention can have a rotatable perforated roll 5, for example, as is shown in FIG. 1. The perforated roll 5 has at least one through-hole 6 that itself preferably has one interior diameter that is flush with the interior diameter of the flow line 1, in this case with the bypass line 3. The perforated roll 5 is, according to FIG. 1, arranged substantially transverse to the bypass line 3 and is mounted by means of bearings 7 and 7′ that are particularly easy to access. When the valve device 2 is in a completely open state, the through-hole 6 of the perforated roll 5 is arranged flush with the bypass line 3 and thereby generates no or only very minimal flow resistance.

In regarding modern cooling or oil circuits in motor vehicles, a plurality of valve devices are arranged in their course that, depending on the embodiment, can lead to flow resistance that is not to be underestimated. This can become so extreme that a pump, which is not shown, for conveying fluid, for example coolant or oil, requires 90% of its performance capacity not to convey the fluid but rather to overcome the flow resistances present in the line system. When it is thus possible to reduce the flow resistance in the flow line 1 or in the entire line network, the capacity of the pumps can be refined as smaller overall, which likewise has a positive effect on energy-savings and the carbon footprint. Such smaller pumps also require less installation space, which is currently likewise a great advantage with regard to the ever-decreasing amount of installation space in modern engine bays.

In regarding the valve device 2 according to FIG. 1, it can be seen that a bearing shaft of the perforated roll 5 runs substantially obliquely to the flow line 1 or obliquely to the bypass line 3, just as the at least one through-hole 6 likewise does in the perforated roll 5. This makes possible a particularly low-energy rotation of the perforated roll 5 for opening or closing the valve device 2 according to the invention. In the embodiment of the valve device 2 shown in FIG. 2, said valve device 2 has a valve piston 8 that does not protrude into a flow cross-section of the flow line 1 or of the bypass line 3 when the valve device 2 is fully open. In this manner as well, flow resistance can be reduced with an open valve device 2. In general, the valve device 2 can be designed as a thermostatic valve, as a bypass valve or as a pressure regulation valve for the operation of which, that is to say for opening and closing the valve device 2, an engine characteristic map thermostat, a magnet apparatus, and/or an electric motor, for example, is provided.

According to FIGS. 3 and 4, an embodiment of the valve device 2 is shown in which it is designed as a ball valve. Ball valves have a bored-through ball as shut-off elements. In most cases, they are used as shut-off valves. Ball cocks are often frequently used in the sanitation field. A bore in the ball 9 corresponds approximately to the interior diameter of the bypass line 3, which results in minimal flow losses. The operation, that is to say a rotating of the ball 9, conventionally requires a 90° multiturn actuator (cf. FIG. 3).

It must be remembered that changes in the fluid temperature can generate such high hydraulic pressure on the volume inside the ball 9 in the closed state that said ball breaks. A small relief valve, for example, can remedy this situation. There are generally ball valves with a floating ball 9 or with a guided ball 9. Sealing gaskets of plastic (often PTFE) are generally fitted between ball 9 and a valve housing. With the “guided ball” principle of construction, only one sealing gasket is required.

In general, with the valve device 2 according to the invention, flow resistance can be reduced within a flow line network, resulting in, first, a reduced requirement for energy to convey the fluid flowing in the flow line network, and, second, the delivery pump required for conveying the fluid can have a smaller design. All in all, the degree of efficiency of the pumps and of the flow line network can be improved, thereby leading to positive developments in both energy reduction and the carbon footprint.

1. A valve device in a flow line of an internal combustion engine, comprising:
an open state wherein the valve device exhibits, at least in the open state, at least one of substantially no and only very minimal flow resistance.

2. The valve device as specified in claim 1, wherein the valve device has a rotatable perforated roll.

3. The valve device as specified in claim 2, wherein at least one through-hole of the perforated roll has an interior diameter that is substantially flush with an interior diameter of the flow line.

4. The valve device as specified in claim 3, wherein a shaft of the perforated roll runs substantially obliquely to the flow line and the at least one through-hole runs substantially obliquely to the shaft of the perforated roll.

5. The valve device as specified in claim 1, wherein the valve device has a valve piston that does not protrude into a cross-section of the flow line when the valve device is substantially fully open.

6. The valve device as specified in claim 1, wherein the valve device is a ball valve.

7. The valve device as specified in claim 1, wherein the valve device is one of a thermostatic valve, a bypass valve and a pressure regulation valve.

8. The valve device as specified in claim 1, wherein at least one of an engine characteristic map thermostat, a magnet apparatus, and an electric motor are provided to operate the valve device.

9. A valve device according to claim 1, wherein the valve device is included with an internal combustion engine.

10. A valve device according to claim 9, wherein the internal combustion engine is included with a motor vehicle.

11. The valve device as specified in claim 1, wherein the valve device is in the flow line of one of a cooling and an oil circuit.

12. The valve device as specified in claim 2, wherein the valve device is one of a thermostatic valve, a bypass valve and a pressure regulation valve.

13. The valve device as specified in claim 2, wherein at least one of an engine characteristic map thermostat, a magnet apparatus, and an electric motor are provided to operate the valve device.

14. The valve device as specified in claim 3, wherein the valve device is one of a thermostatic valve, a bypass valve and a pressure regulation valve.

15. The valve device as specified in claim 3, wherein at least one of an engine characteristic map thermostat, a magnet apparatus, and an electric motor are provided to operate the valve device.

16. The valve device as specified in claim 4, wherein the valve device is one of a thermostatic valve, a bypass valve and a pressure regulation valve.

17. The valve device as specified in claim 4, wherein at least one of an engine characteristic map thermostat, a magnet apparatus, and an electric motor are provided to operate the valve device.

18. The valve device as specified in claim 5, wherein the valve device is one of a thermostatic valve, a bypass valve and a pressure regulation valve.

19. The valve device as specified in claim 5, wherein at least one of an engine characteristic map thermostat, a magnet apparatus, and an electric motor are provided to operate the valve device.

20. The valve device as specified in claim 6, wherein the valve device is one of a thermostatic valve, a bypass valve and a pressure regulation valve.
